(19) United States
(12) Patent Application Publication
(10) Pub. No.: US 2020/0211112 A1
(43) Pub. Date: Jul. 2, 2020

(54) Wireless Base Station Crowdfunding

(71) Applicant: VOLKAN SEVINDIK, PARKER, CO (US)

(72) Inventor: VOLKAN SEVINDIK, PARKER, CO (US)

(21) Appl. No.: 16/747,485

(22) Filed: Jan. 20, 2020

Related U.S. Application Data
(60) Provisional application No. 62/785,225, filed on Dec. 27, 2018.

(51) Int. Cl. G06Q 40/04; H04W 88/08; H04W 24/02

(52) U.S. Cl. CPC G06Q 40/04; H04W 24/02; H04W 88/08

(57) ABSTRACT

Wireless base station crowdfunding method to buy, to sell, to transfer, to resell, to exchange at least one share of ownership of a base station is disclosed. Base station value calculation unit calculates value of base station and base station cluster, issues stocks and derivative contracts, and determines value of issued stocks and derivative contracts. Trading unit is used to buy, to sell, to resell, to transfer, to exchange stocks or shares of base station or base station cluster from/to any other investor including wireless service provider. Derivatives of base station or base station cluster is created using any underlying tangible and intangible assets of base station or base station cluster. Smart contract is created for each buy, sell, transfer, resell, exchange agreement. Smart contract and all trading information about stocks, derivative contracts are recorded in a blockchain.

### CROSS REFERENCE TO A RELATED APPLICATION

This application claims the benefit of U.S. Provisional Application Ser. No. 62/785,225, filed 24 Jan. 2019, the disclosure of which is hereby incorporated by reference in its entirety, including all figures, tables, and drawings.

### BACKGROUND OF THE INVENTION

Service operators invest in network deployment by using their own financial resources. Network deployment consists of activities of placing base stations at specific geographical regions to deliver data and voice services to subscribers. Each base station deployed has capital expenditures and operational expenditures associated with its deployment. Capital expenditures are hardware and software costs of base station. Operational expenditures are any expenses that has to be made to keep base station up and running, that is, to keep base station operational. Operational expenditures are but not limited to, backhaul costs, rent for real state, electrical/power consumption cost, cooling cost, cost of optimization services, engineering cost, legal costs, and cost of personnel.

Each base station delivers data and voice services to subscribers of service provider. And each base station makes revenue, and profit from that revenue. Profit of a base station is owned by service provider. Service operator makes profit at some base stations, and loss money at some base stations. However, in overall, service operators should make profit in order to keep its operations and to keep delivering data and voice services to its subscribers.

Current network deployment model is not very scalable since it depends on service provider's profit to expand the network. That is, one of the reasons, why there are many big service providers in a country, and there are not really many small service operators. Lack of competition, that is, small service providers, increases service prices for subscribers, and lack of competition also creates monopoly on wireless data and voice service delivery. One very good example of this in US, is cable providers. You cannot change cable provider since there is no competitor in the same region that you are receiving cable services. All of us living in US has to stuck with service that we do not prefer, and does not meet our expectations in terms of data speed, and service quality. The same monopoly structure is starting to show itself in wireless operator space, in where either we do not have good wireless coverage because of the lack of investment from operators, or we have good coverage coming with huge phone bills. There should be a way that wireless service operators to work with subscribers and investors to invest in their network deployment, and share the profit created by delivering superior services to its subscribers. Subscribers who are funding the network deployment will receive profit shares of base stations, which will be a good investment, for retirement or for future school tuition or for healthcare expenses, or just for a big purchase planned in future.

### BRIEF DESCRIPTION OF THE DRAWINGS

FIG. 1 shows hardware components of base station.

FIG. 2 shows hardware components of base station valuation unit.

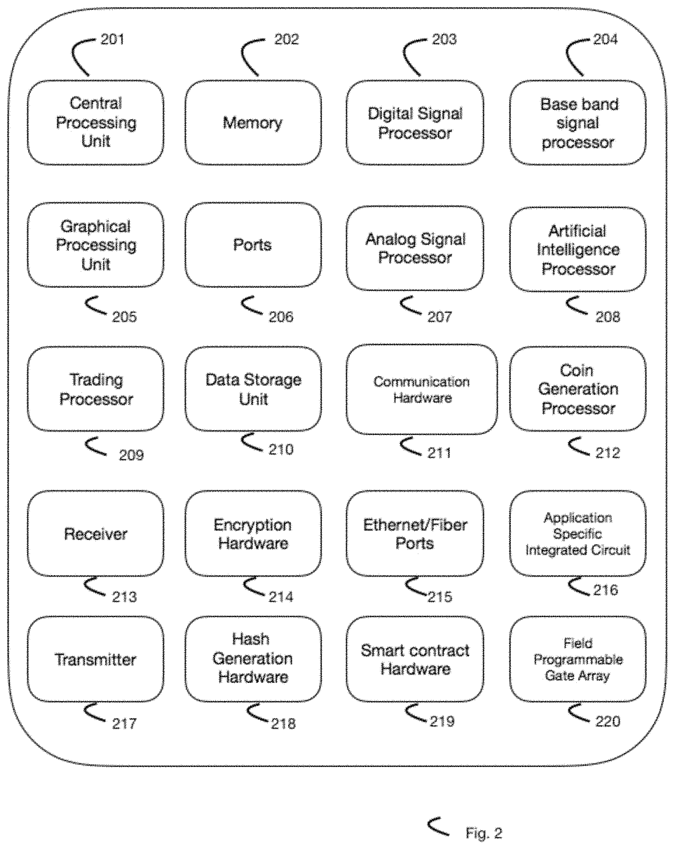

FIG. 3 shows hardware components of trading unit.

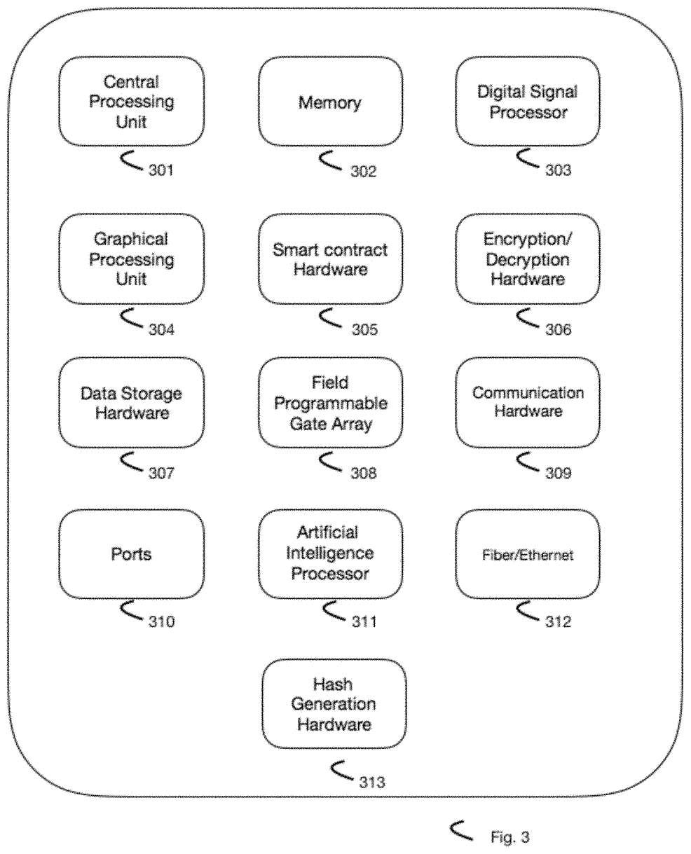

FIG. 4 shows software components of base station running on hardware components of base station as shown in FIG. 1.

FIG. 5 shows software components of base station valuation unit running on hardware components of base station valuation unit as shown in FIG. 2.

FIG. 6 shows software components of trading unit running on hardware components of trading unit as shown in FIG. 3.

FIG. 7 shows base station valuation unit, trading unit, investors, and communication between them.

FIG. 8 shows base station value calculation units and the connections between base stations and base station value calculation units.

FIG. 9 shows base station value calculation unit and set of tasks base station valuation unit performs, and calculates.

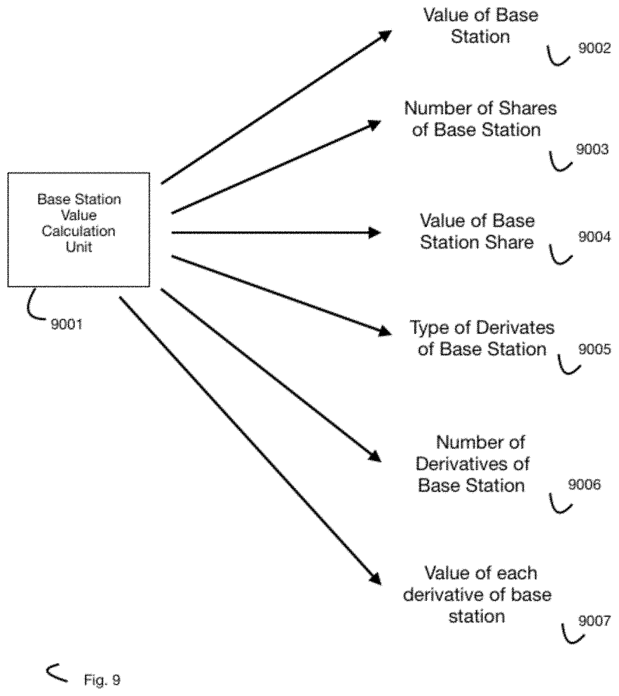

FIG. 10 shows trading unit, base station calculation units, accounting system, and banks; and connections between them.

FIG. 11 shows base station value calculation unit which is part of base station.

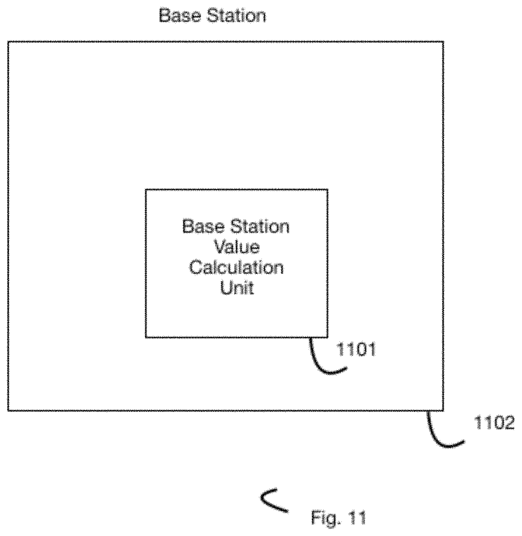

FIG. 12 shows trading unit, and base station and cluster ownership table.

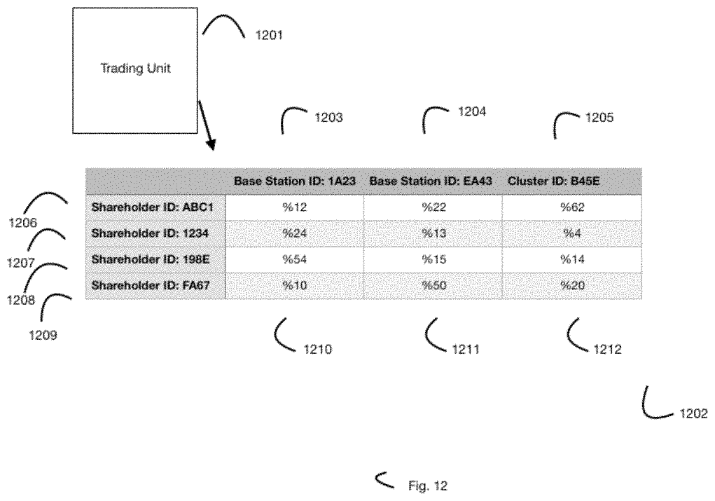

FIG. 13 shows base station value calculation unit, and table showing value of each base station, each base station cluster, shareholders, and, metrics used for base station valuation.

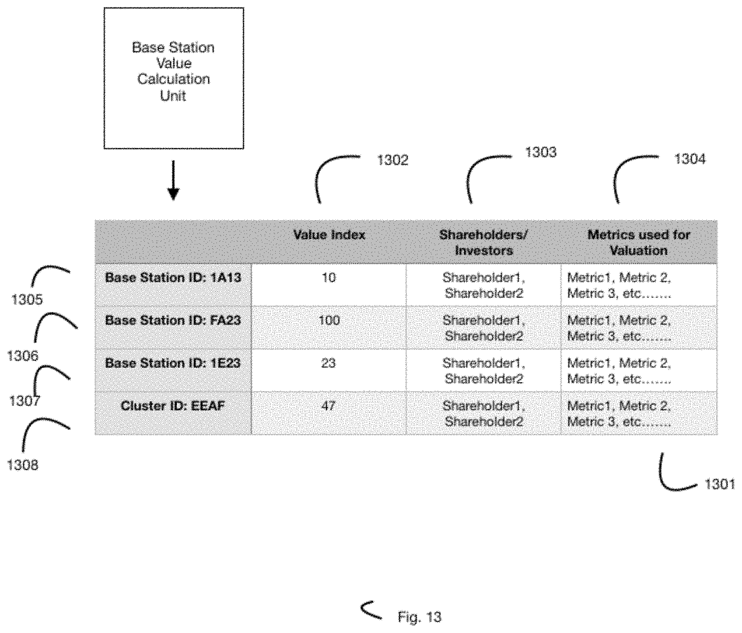

FIG. 14 shows genesis block (beginning block), subsequent blocks of blockchain, and connection between blocks of blockchain.

FIG. 15 shows core network components.

FIG. 16 shows base stations, core network, subscribers and connections between them.

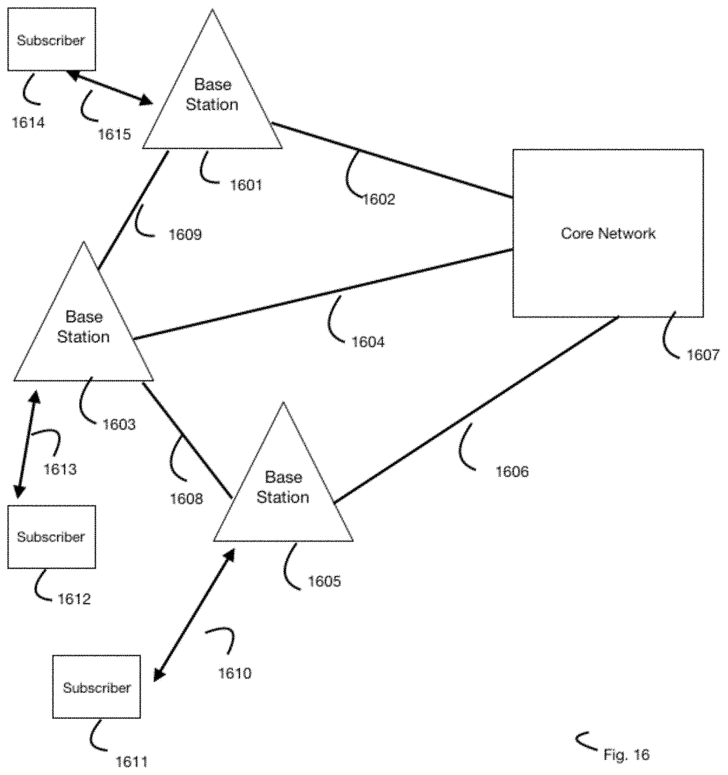

FIG. 17 shows trading unit that is part of core network.

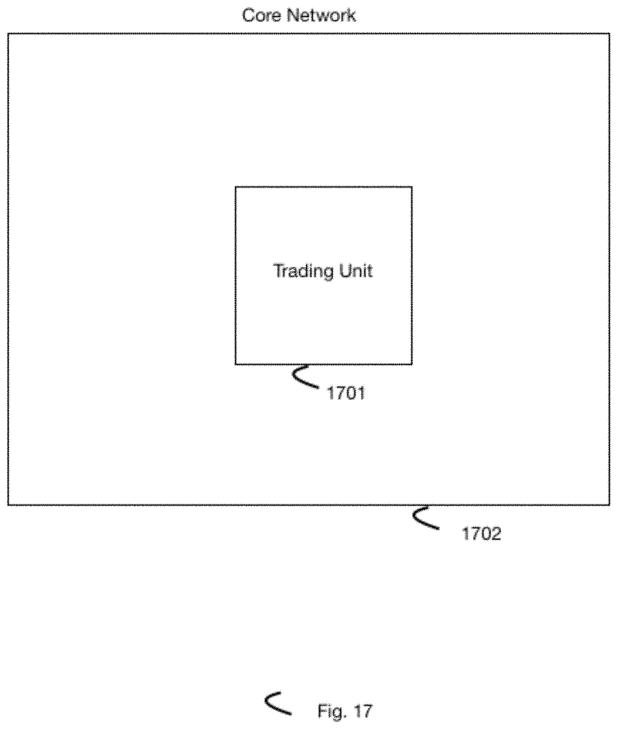

FIG. 18 shows base station cluster.

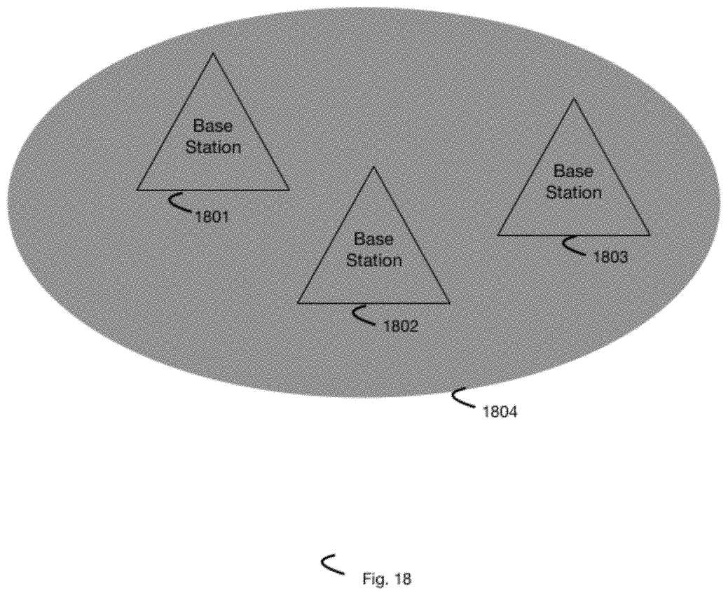

FIG. 19 shows trading unit user interface.

FIG. 20 shows trading unit user interface.

FIG. 21 shows content of a block in a blockchain.

### BRIEF SUMMARY OF THE INVENTION

This disclosure presents a method of crowdfunding network deployment and network operation of service provider. Cost of network deployment is shared by funders/investors by giving share/stock of base station or base station cluster to funders/investors. Each base station issues stocks/shares to investors, and depending on value of base station or base station cluster, each share/stock will have a certain purchase price. Investors will own share in base station or base station cluster by buying stock of a base station or base station cluster.

Value of base station or base station cluster is calculated by newly introduced base station value calculation unit which uses a set of inputs regarding a base station or base station cluster to calculate stock price of a base station or base station cluster. In addition to stocks, financial derivatives are also issued for base station and base station cluster, and investors/funders also buy issued derivative contracts. Base station value calculation unit is connected to each base station in network either directly or indirectly. Base station value calculation unit has artificial intelligence hardware and software components to dynamically calculate buying/selling/reselling/exchanging/transferring price of each issued stock, share and derivative contract for base station and base station cluster. Artificial intelligence software uses various machine learning algorithms to predict future value of base station and base station cluster and issues stocks, shares, and derivative contracts based on these predictions with right price for each stock, for each share and for each derivative contract.

Trading unit is used to buy, to sell, to resell, to exchange, to transfer stock, and derivative contracts. Trading unit offers user interface to investors/funders and wireless service provider to perform all trading tasks. Trading unit communicates with base station value calculation units, with accounting systems, and banks. Trading unit has artificial intelligence hardware and software components to enable automated trading among investors, base stations, base station clusters and wireless service provider.

### DETAILED DESCRIPTION

Reference is now made to the drawings wherein like numerals refer to like parts throughout.

As used herein, the term “base station” refers generally and without limitation to a network node which enables communication between a user or client device and another entity within a network, such as for example a cellular NB, a cellular eNB, eNB New Radio, a Wi-Fi AP, Bluetooth Node, Satellite Node or a Wi-Fi-Direct enabled client or other device acting as a Group Owner (GO).

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terms “client device” or “user device” or “UE” include, but are not limited to, set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “headend” or “backend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, over-the-top services, streaming services, and the Internet.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), and 4G/4.5G LTE.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terminology “computer” or “computing device” includes any unit, or combination of units, capable of performing any method, or any portion or portions thereof, disclosed herein. For example, the “computer” or “computing device” may include at least one or more processor(s).

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein the terms “5G” and “New Radio (NR)” refer without limitation to apparatus, methods or systems compliant with 3GPP Release 15, and any modifications, subsequent Releases, or amendments or supplements thereto which are directed to New Radio technology, whether licensed or unlicensed.

As used herein the terms “4G” and “4G eNB” refer without limitation to apparatus, methods or systems compliant with 3GPP Release 8, and any modifications, subsequent Releases, or amendments or supplements thereto which are directed to New Radio technology, whether licensed or unlicensed.

As used herein the terms “5G Core” and “Core Network” refer without limitation to apparatus, methods or systems compliant with 3GPP Release 15, and any modifications, subsequent Releases, or amendments or supplements thereto which are directed to Core Network technology.

As used herein the terms “4G Core” and “Evolved Packet Core (EPC)” refer without limitation to apparatus, methods or systems compliant with 3GPP Release 8, and any modifications, subsequent Releases, or amendments or supplements thereto which are directed to Core Network technology, whether licensed or unlicensed.

As used herein, the terms “network” and “bearer network” refer generally to any type of telecommunications or data network including, without limitation, satellite networks, telco networks, data networks (including WANs, MANs, LANs, WLANs, intranets, and internets), and hybrid fiber coax (HFC) networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., 3GPP, 3GPP2, LTE/LTE-A/LTE-U/LTE-LAA, 5G NR, SONET, Frame Relay, DOCSIS, IEEE Std. 802.3, ATM, X.25, WAP, SIP, UDP, FTP, RTP/RTCP, H.323, etc.).

As used herein, the term “network interface” refers to any signal or data interface with a component or network including, without limitation, those of the USB (e.g., USB 2.0, 3.0. OTG), FireWire (e.g., FW400, FW800, etc.), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), LTE/LTE-A/LTE-U/LTE-LAA, Wi-Fi (802.11), WiMAX (802.16), Z-wave, PAN (e.g., 802.15), or power line carrier (PLC) families.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “Wi-Fi” refers to, without limitation and as applicable, any of the variants of IEEE Std. 802.11 or related standards including 802.11 a/b/g/n/s/v/ac/ad/ax or 802.11-2012/2013, 802.11-2016, as well as Wi-Fi Direct (including inter alia, the “Wi-Fi Peer-to-Peer (P2P) Specification”, incorporated herein by reference in its entirety).

As used herein, the term “wireless” means any wireless signal, data, communication, or other interface including without limitation 3GPP/3GPP2, Wi-Fi, Bluetooth/BLE, HSDPA/HSUPA, TDMA, CBRS, CDMA (e.g., IS-95A, WCDMA, etc.), FHSS, DSSS, GSM, PAN/802.15, WiMAX (802.16), 802.20, Zigbee®, Z-wave, narrowband/FDMA, OFDM, PCS/DCS, LTE/LTE-A/LTE-U/LTE-LAA, 5G NR, LoRa, IoT-NB, SigFox, analog cellular, CDPD, satellite systems, millimeter wave or microwave systems, acoustic, and infrared (i.e., IrDA).

As used herein, the term “base station” refers to any 3GPP-compliant node including without limitation eNBs (eUTRAN) and gNBs (5G NR).

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

For simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

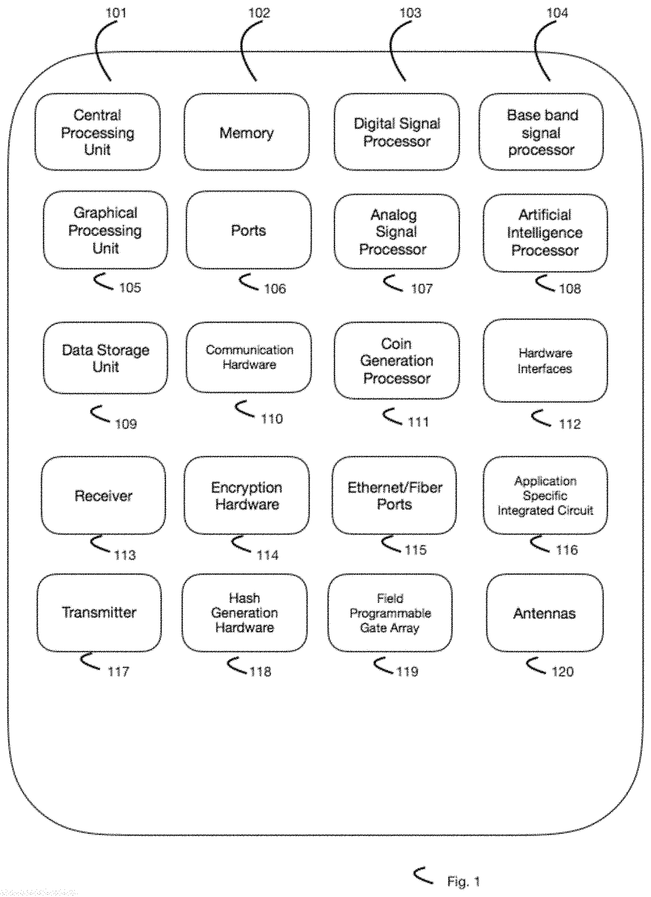

Base station means as microcell, macrocell, femtocell, smallcell, or any other type of wireless communication device used to send and to receive data in wireless communication system. Hardware components of base station (FIG. 1) are but not limited to central processing unit 101, memory 102, digital signal processor 103, baseband signal processor 104, graphical processing unit 105, ports 106, analog signal processor 107, artificial intelligence processor 108, data storage unit 109, communication hardware 110, coin generation processor 111, hardware interfaces 112, receiver 113, encryption hardware 114, ethernet/fiber ports 115, application specific integrated circuit 116, transmitter 117, hash generation hardware 118, field programmable gate array 119, antennas 120. All hardware components of base station can communicate with each other through defined hardware interfaces, ports, communication paths, and communication circuits.

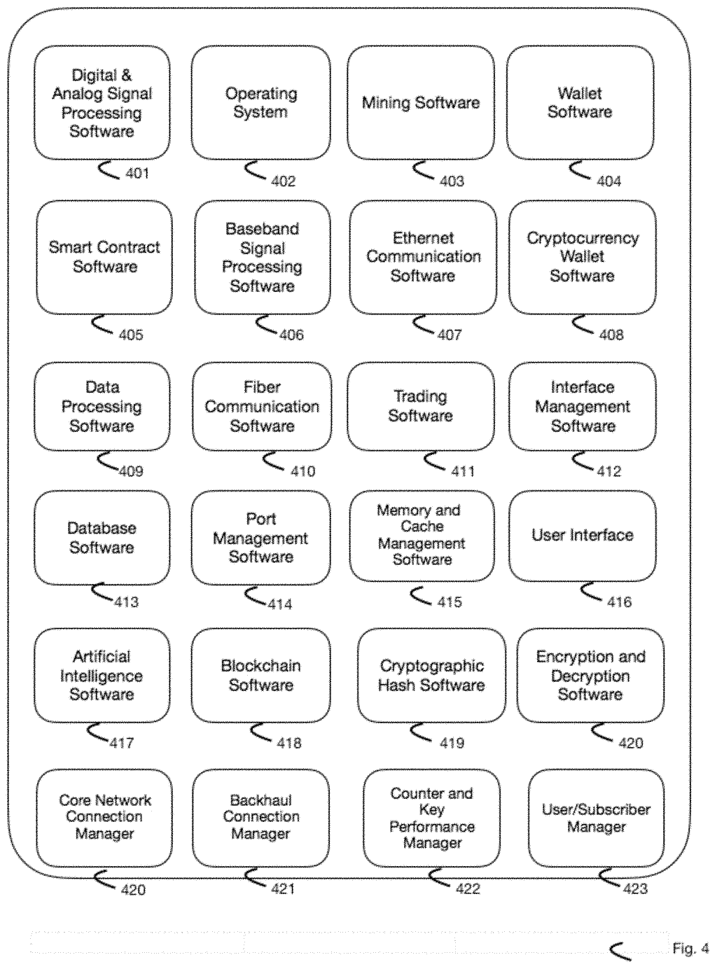

Base station has software components (FIG. 4) running on base station's hardware components (FIG. 1). Software components of base station are but not limited to analog/digital signal processing software 401, operating system 402, mining software 403, wallet software 404, smart contract software 405, baseband signal processing software 406, ethernet communication software 407, cryptocurrency wallet software 408, data processing software 409, fiber communication software 410, trading software 411, interface management software 412, database software 413, port management software 414, memory and cache management software 415, user interface 416, artificial intelligence software 417, blockchain software 418, cryptographic hash software 419, encryption and decryption software 420, core network connection manager 420, backhaul connection manager 421, counter and key performance indicator manager 422, user/subscriber manager 423.

A wireless service provider, service provider, network provider, data service provider, voice service provider, data and voice service provider, communication service provider, cellular communication service provider terms have the same meaning and these terms are used interchangeably in this disclosure.

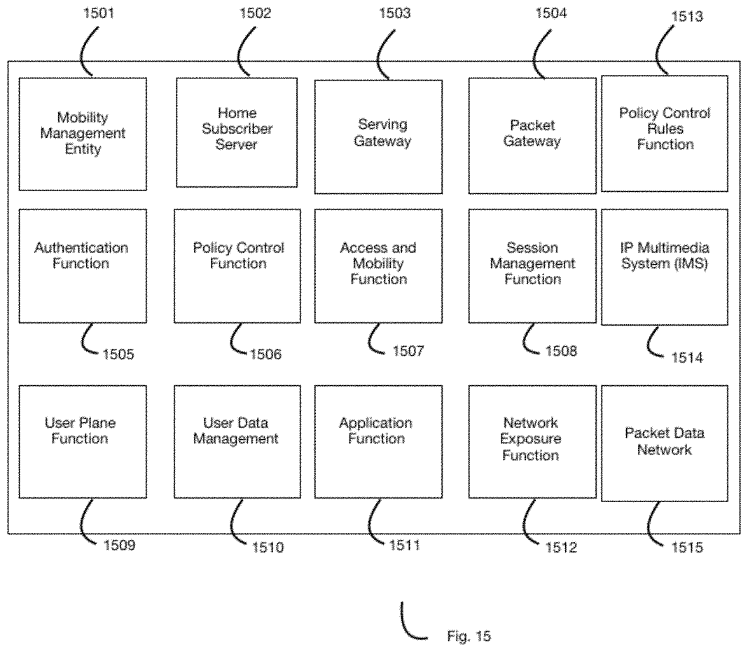

Base station 1601 is connected to core network 1607 through wired or wireless connections, 1602, 1604, 1606. Core network 1607 consists of mobility management entity 1501, home subscriber server 1502, serving gateway 1505, packet gateway 1504, authentication function 1505, policy control function 1506, access and mobility management function 1507, session management function 1508, user plane function 1509, user data management function 1510, application function 1511, network exposure function 1512. FIG. 15 shows all mentioned components of core network.

Hardware components of base station value calculation unit are but not limited to central processing unit 201, memory 202, digital signal processor 203, baseband signal processor 204, graphical processing unit 205, ports 206, analog signal processor 207, artificial intelligence processor 208, trading processor 209, data storage unit 210, communication hardware 211, coin generation processor 212, receiver 213, encryption hardware 214, ethernet/fiber ports 215, application specific integrated circuit 216, transmitter 217, hash generation hardware 218, smart contract hardware 219, field programmable gate array 220. All hardware components of base station valuation unit can communicate with each other through defined hardware interfaces, ports, communication paths, and communication circuits.

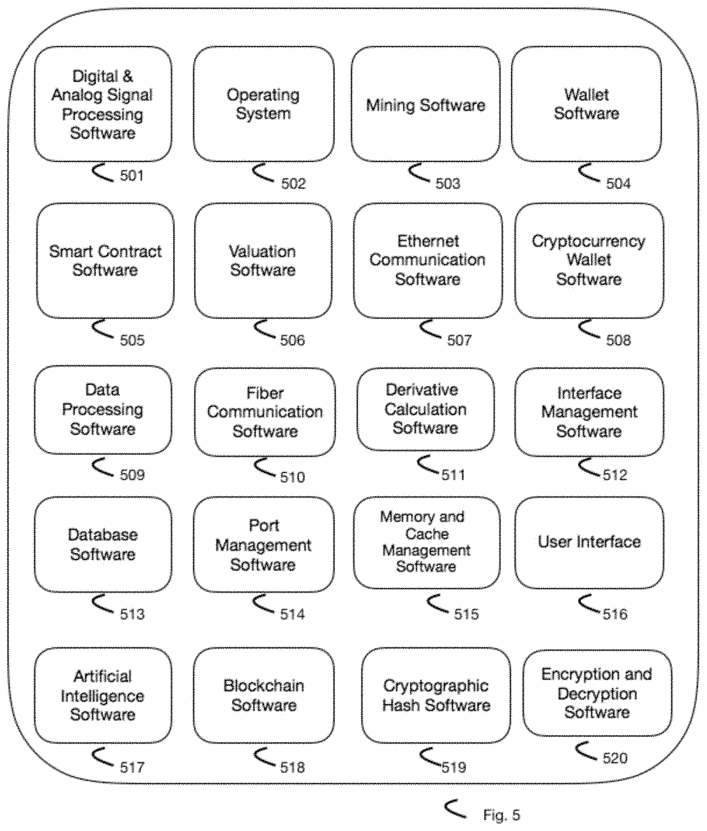

Software components of base station value calculation unit (FIG. 5) are but not limited to digital signal processing software 501, analog digital signal processing software 502, mining software 503, wallet software 504, smart contract software 505, valuation software 506, ethernet communication software 507, cryptocurrency wallet software 508, data processing software 509, fiber communication software 510, derivative calculation and valuation software 511, interface management software 512, database software 513, port management software 514, memory and cache management software 515, user interface 516, artificial intelligence software 517, blockchain software 518, cryptographic hash software 519, encryption and decryption software 520.

Hardware components of trading unit are but not limited to central processing unit 301, memory 302, digital signal processor 303, smart contract hardware 305, encryption/decryption hardware 306, data storage hardware 307, field programmable gate array 308, communication hardware 309, ports 310, artificial intelligence processor 311, fiber/ethernet 312, hash generation hardware 313.

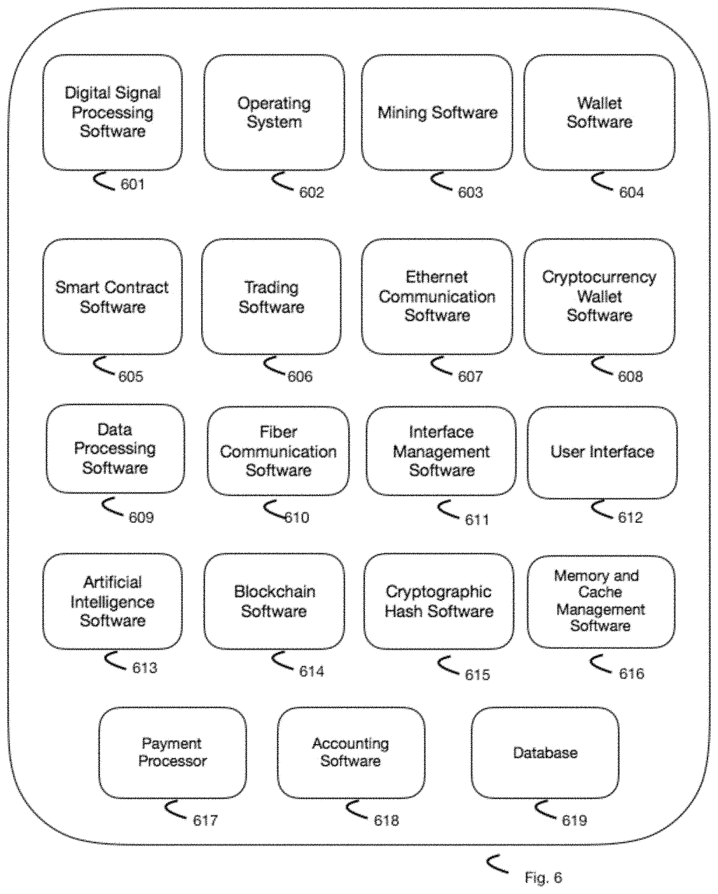

Software components of trading unit (FIG. 6) are but not limited to digital signal processing software 601, analog signal processing software 602, mining software 603, wallet software 604, smart contract software 605, trading software 606, ethernet communication software 607, cryptocurrency wallet software 608, data processing software 609, fiber communication software 610, interface management software 611, user interface 612, artificial intelligence software 613, cryptographic hash software 615, memory and cache management software 616, payment processor 617, accounting software 618, database 619.

Core network is 4G Core network (Evolved Packet Core) which consist of components mobility management entity 1501, home subscriber server 1502, serving gateway 1503, packet gateway 1504. Core network can only be 5G Core network which consists of components authentication function 1505, policy control function 1506, access and mobility function 1507, session management function 1508, user plane function 1509, user data management 1510, application function 1511, network exposure function 1502. Core network can be 4G+5G Core network which consists of all 4G network components together with 5G network components. Each base station in the network, 1601, 1603, 1605 is connected to core network 1607, through any type of wireless or wires connection, 1602, 1604, 1606.

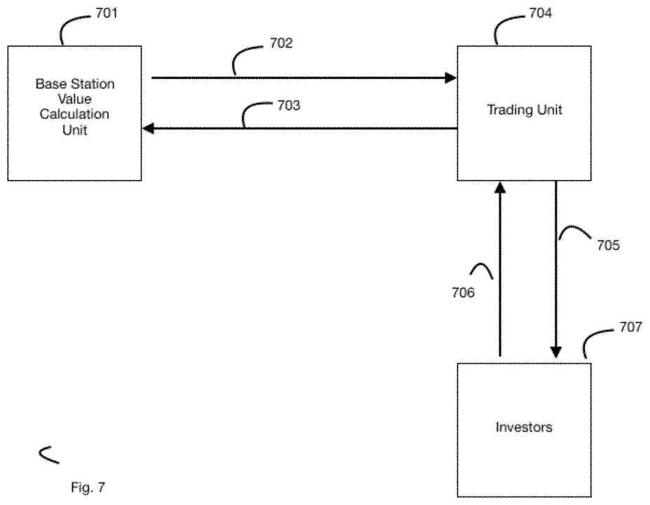

Base station value calculation unit 701 calculates value of base station at predefined time intervals or at random moments of time or based on a triggering event. Base station calculation unit communicates with trading unit 704 at predefined time intervals, periodically or non-periodically. Base station value calculation unit communicates with trading unit over 702 interface, and trading unit communicates with base station value calculation unit over 703 interface. Trading unit 704 shares all information it has with investors 707. Trading unit communicates with investors over 705 interface, and investors communicates with trading unit over 706 interface. All components and interfaces are shown in FIG. 7.

Trading unit 1202 has a table 1202 holding base station identities/identifications 1203, 1204, cluster identities/identifications 1205, and shareholder/investor identities/identifications 1206, 1207, 1208, 1209, and ownership percentage of each shareholder/investor 1210, 1211, 1212.

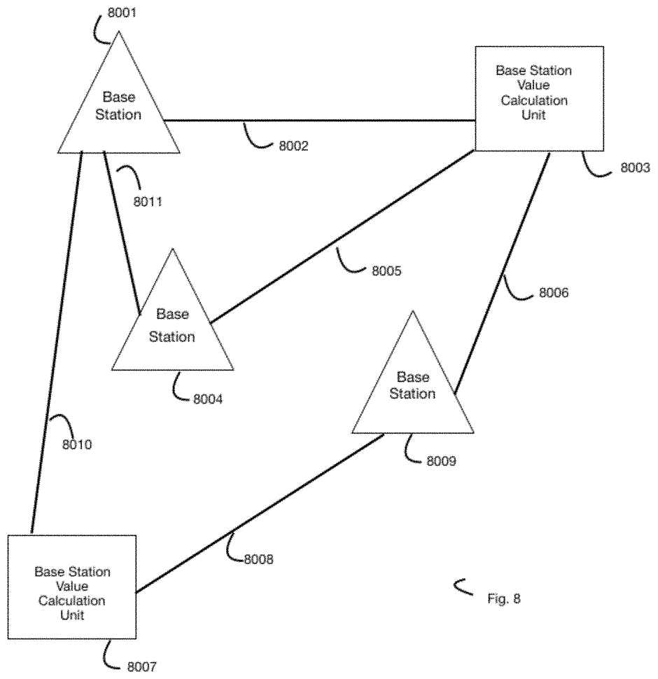

Base station value calculation unit has a table 1301, holding base station identities/identifications 1305, 1306, 1307, base station cluster identities/identifications 1308, and value index 1302 of each base station in operator's network and value index of base station cluster, number of shareholders/investors 1303 of each base station and base station cluster, and metrics used for valuation 1304 used to find value of base station, and base station cluster. Base station value calculation unit 9001 calculates value of base station, number of shares of base station, value of base station shares, type of derivatives of base station, number of derivatives of base station, value of each derivative of base station. Base station value calculation unit calculates the value of a single base station, or can calculate the total value of a base station cluster 1804, where a cluster, 1804 has at least one base station 1801, 1802, 1803 in it. Base station calculation unit is connected to each base station (FIG. 8) in network directly 8002, 8006, 8008 or indirectly 8005+8011. There is at least one base station calculation unit in network, 8003, 8007. Each base station can be connected to a different base station value calculation unit. Base station value calculation unit can be a standalone unit located outside of service provider's network; or base station value calculation unit 1101, can be part of base station, 1102.

Base station is crowdfunded to individual(s), business(es), private investor(s), stock market, or any other investor(s) which are willing to pay fiat currency, cryptocurrency, precious metal, commodity or any other type of valuable asset to have ownership in part of or fraction of or full of a base station.

Ownership is defined as the number of shares of a base station that owner holds or ownership is defined as percentage owned out of total base station asset. If a base station is counted as 100% asset, funder/investor can own any portion or percentage of 100%. For example, one funder can own 5% of a base station, other funder can own %12 of the same base station, and wireless service provider can own 45% of the base station, and so on. Any funder/investor can own any percentage of the base station's total value with sum of all percentages being equal to 100. Alternatively, each base station can issue stocks of ownership. For example, a base station can issue 10000 stocks that each stock value is calculated based on the total value of a base station. Each investor/stockholder/funder can buy at least one stock or a fraction of stock of a base station to own a share in a base station.

Base station owner can be wireless service operator, wireline service operator, any other company, individual investor or investment company. Owner, funder, investor, shareholder, individual investor, private investor are the same terms, and used interchangeably in this disclosure.

Base station's cost of hardware, cost of software, backhaul cost, front haul cost, heating/cooling cost, electricity cost, and internet connection cost is calculated, and the profit/loss of base station is calculated using revenue of base station, cost of operation, cost of deployment.

Base station makes money by delivering services to anyone interested. These services are data services, voice services, multimedia services, video services, broadcast services, television services, radio services, emergency services, and any other services that require data and voice connection. Subscribers/users pay for any services delivered by base station to themselves, and depending on the number of subscribers, number of services delivered, type of services delivered, each base station can make different amount of revenue and profit.

Each base station can make profit or loss depending on an income made from provided services, and the costs of operation. Profit is shared among the investors of that particular base station, and if there is loss, no profit sharing is done. Profit sharing is done at any time or depending on a particular profit-sharing schedule agreed among a base station, its investor, and wireless service provider.

Each time, base station makes a profit, some percentage of this profit is shared by wireless service provider who deploys base station. This profit sharing is similar to distribution paid by a company to its stockholders.

If base station does not make profit for a few number of quarters, at least one owner of base station can request at least one of increasing coverage of base station, serving users who consume huge amount of data, reducing coverage of base station, increasing frequency spectrum used by base station, decreasing frequency spectrum used by base station, increasing number of services offered by base station, decreasing number of services offered by base station, increasing capacity of base station, decreasing capacity of base station, optimizing parameters of base station, changing hardware of base station, improving hardware of base station, upgrading hardware of base station, upgrading software of base station, increasing backhaul capacity of base station, decreasing backhaul capacity of base station. The main purpose of any of these changes is to make base station profitable.

Crowdfunding is done based on amount of money required to launch base station and time required to launch the base station. If the required amount of resources cannot be collected till the launch deadline, then base station is launched with the resources of wireless service provider together with all investors who are willing to invest their resources during crowdfunding timeframe.

A new smart contact is digitally signed between investor/funder/shareholder/stockholder of the base station and the wireless service provider. This smart contact is a legally binding digital agreement between investor and wireless service provider. Once smart contact is signed between investor of the base station and the service provider; it is a legally binding legal contract exactly the same as the physical legal contract. Each smart contract is recorded in the blockchain. Smart contract comprising at least one of the fields of;
Identify of investor,
Identify of base station,
Amount of money invested by investor/shareholder/stockholder,
Number of stocks offered by base station, by base station cluster,
Number of stocks investor buys/sells/resells/exchanges,
Cost of base station, base station cluster,
Profit sharing schedule of base station, base station cluster,
Conditions to execute smart contract,
Conditions to revoke smart contract.
   When base station becomes profitable, depending on profit sharing schedule, smart contract is executed to share base station profit with an investor. For each investor, a different smart contract is created between wireless service provider and investor.

Between every shareholder/investor/funder of a base station, there is a new smart contract signed and recorded in the blockchain.

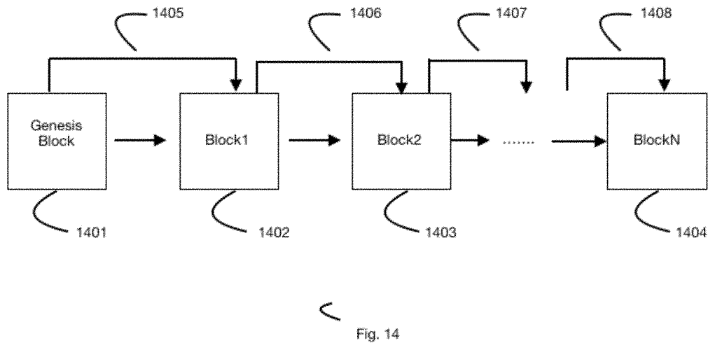

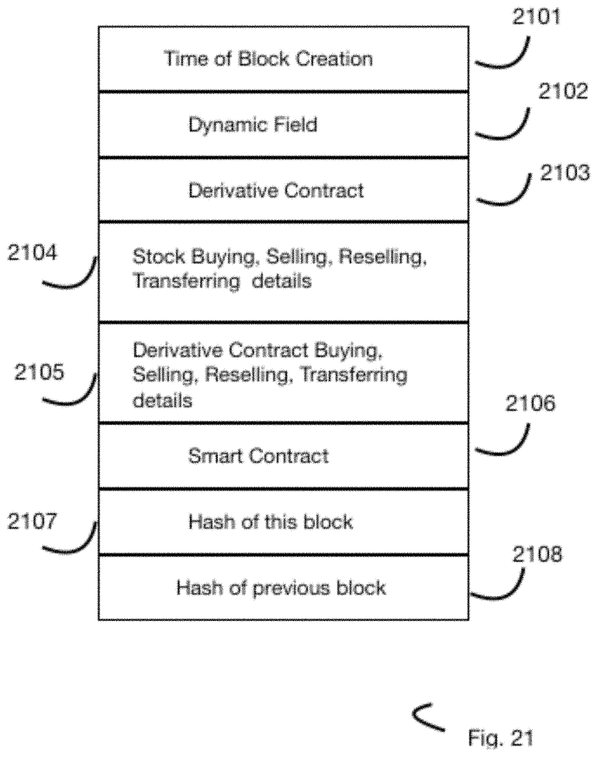

Blockchain is a distributed ledger technology that stores and manages data in an encrypted format and in the block which can store any amount of data defined by the blockchain. Blockchain (FIG. 14) consists of blocks 1401, 1402, 1403, 1404, and starts with a specific block called genesis block 1401. Each block provides input to the block coming after, and this input is in a specific format and encrypted. Any kind of information can be held as part of an existing block or as a new block in the blockchain. FIG. 21 shows content of a block in blockchain. Block stores at least one of time of block creation 2102, dynamic field 2102, details of derivative contract 2103, stock buying, selling, reselling, transferring, details 2104, derivative contract buying, selling, reselling, transferring details 2105, smart contract 2106, hash value of the current block 2107, hash value of previous block 2108. Dynamic field 2101 is used to create a block hash value satisfying certain properties as in Proof of Work consensus algorithm. Any other consensus algorithm is used to create a block, and to reach on a consensus on the content of a block to be recorded in a blockchain.

Value of a base station is increased and decreased based on several factors. Original funder of the base station can sell his ownership in the base station to a different investor/funder. Original funder of the base station can make capital gains by selling his/her shares to a different funder/investor. Buying a base station share/stock, selling a base station share/stock, exchanging base station share/stock is performed by investor using trading unit. Trading unit can be a standalone server located anywhere inside or outside of wireless operator's network, or trading unit can be located inside core network, 1701.

Owners of the base station have right to manage and to optimize the performance of base station using third party services, consulting firms, engineering firms, and any company that can manage and optimize the base station performance on the behalf of owners. If majority owners of a base station is not satisfied with the performance and corresponding profit of a base station, then owners/funders can use any performance/profit boosting activities in order to improve the performance of base station and profit of base station. Cost of these activities are deducted from revenue at the time of profit sharing.

Value of the base station changes based on at least one of location, amount of frequency spectrum used by base station, age of base station, number of subscribers base station serves, amount of traffic that base station sends and receives, type of backhaul connection, capacity of backhaul connection, number of sectors, number of antennas, distance to data center, software version running, age of hardware running, number of alarms, key performance indicators, performance counters, type of wireless standard running, type of phones that base station is serving, services and application that base station is sending, receiving, coverage of base station, capacity of base station, average time duration that base station is live, number of current owners of base station, type of current owners, amount of money raised, percentage owned by service provider, operational expenditure of base station, amount of liability of base station (such as electricity bill, utility bill, cooling bill, real state rent bill, backhaul rent bill, money owned to its current owners/shareholders).

Each smart contract created during ownership process has at least one of parties involved in smart contract, monetary amount of smart contract, time duration of smart contract, set of conditions in order to keep smart contract live, and set of conditions to break the contract. Each smart contract, 2106 is recorded in a block in blockchain (FIG. 21).

Each base station's value changes similar to stock prices in a stock market. Value can go up, go down, and stay the same at any time; and shareholders/investors/owners can buy and sell the share of base station at any time to any party.

Shareholders of a base station can trade real value of base station, and also shareholder of base station can trade derived value of a real asset of the base station itself. Base station financial derivatives are financial contracts created based on the underlying base station physical asset, or any other tangible or intangible asset base station has. Tangible assets are but not limited to hardware, software, cabling, and any hardware and software components that are needed to run base station, and to execute all tasks of base station. Intangible assets are but not limited to any service, application, and traffic type base station delivers, number of subscribers base station delivers its services to, quality of service base station delivers, quality of experience base station delivers, wireless standard that base station runs, software version of software running in base station, future upgrade plans of base station, future plans of wireless service provider, current profit amount of base station, amount of assets base station has, amount of liabilities base station has, amount of base station's equity, base station's cash flow, base station's income, base station's expense, earning per hertz, earning per subscriber, earning per hertz per subscriber, earning per square foot of coverage, earning per kilobyte/megabyte/gigabyte/terabyte/exabyte/‘x’ byte of data delivered, where x represents any data unit, earning per voice minute, earning per default bearer, earning per dedicated bearer, earning per postpaid subscriber, earning per prepaid subscriber, number of services that base station delivers, diversity of services that base station delivers, total market value of wireless service providers. Base station value calculation unit creates derivatives for base station and base station cluster, and calculates value of each derivative contract. Investors of base station can invest in derivatives through short and long positions. Long position means that investors believe that value of base station will increase in the future, and short position means that value of base station will decrease in the future.

Derivative, derivative contract terms have exactly the same meaning in this disclosure.

Blockchain consists of blocks 1401, 1402, 1403, 1404, each block provides input 1405, 1406, 1407, 1408 to next block. Blockchain starts with an initial block called genesis block 1401. Blockchain is used to record all transactions in network.

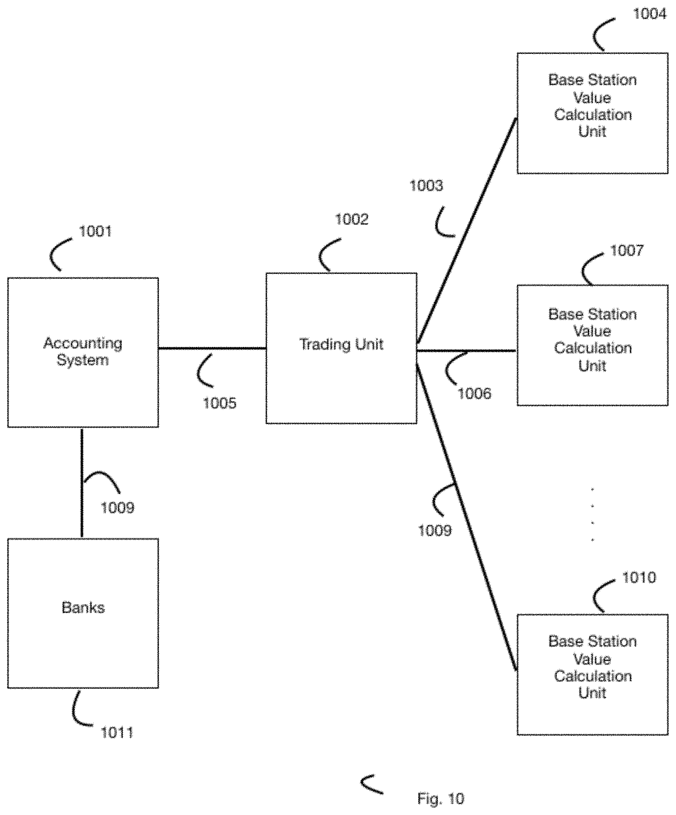

FIG. 10 shows base station value calculation units 1004, 1007, and 1010 which are connected to a single trading unit 1002. There might be one to many connection relationships between trading unit and base station calculation unit. Trading unit 1002 is connected to accounting system 1001, and accounting system 1001 is connected to a bank 1011 or group of banks.

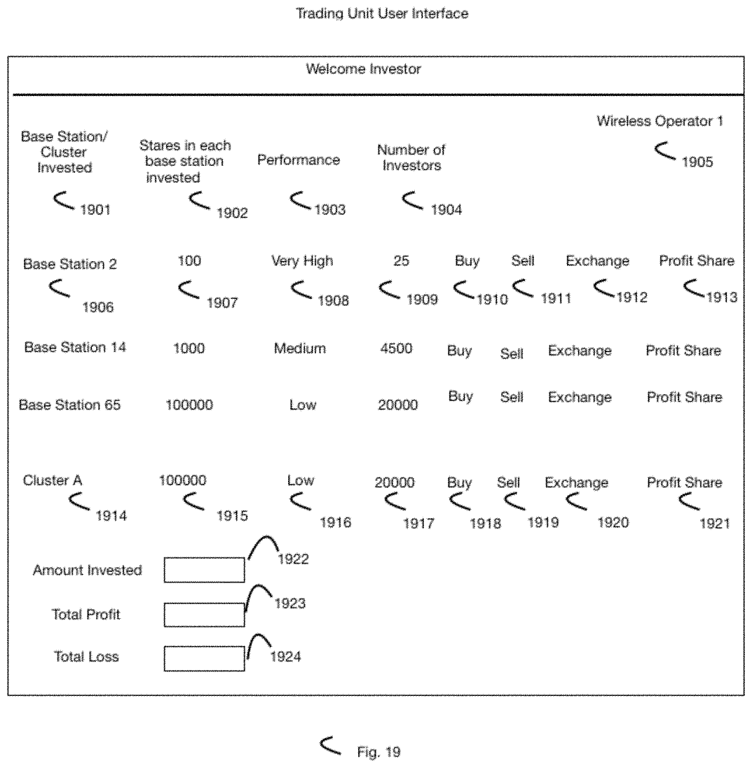

FIG. 19 shows user interface of trading unit. Investor will see wireless operator 1905 that they are investing in base stations of. Base Station/Cluster Invested 1901, shares in each base station invested 1902, performance of base station 1903, and number of investors investing in a base station 1904 are shown on user interface. Investor can buy 1910, sell 1911, exchange 1912 shares of each base station. Profit share schedule, and how much profit will be shared in the future or was shared in the past is shown under profit share 1913 section. Investor also sees cluster 1914 that investor has invested. Shares in each cluster invested 1915, performance of cluster 1916, and number of investors investing in a cluster 1917 are shown on user interface. Investor can buy 1918, sell 1919, exchange 1920 shares of each cluster. Cluster profit share schedule, and how much profit will be shared in the future or was shared in the past is shown under profit share 1921 section.

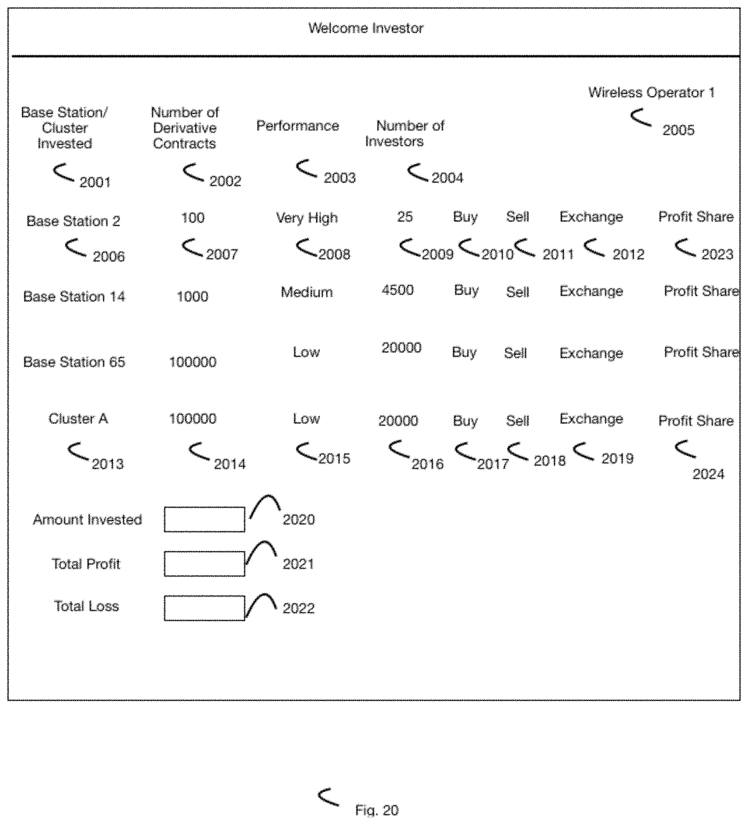

FIG. 20 shows user interface of trading unit. Investor will see wireless operator 2005 that they are investing in base stations of. Base Station/Cluster Invested 2001, number of derivative contracts invested 2002, performance of base station 2003, and number of investors investing in a base station 2004 are shown on user interface. Investor can buy 2010, sell 2011, exchange 2012 derivatives of each base station. Profit share schedule, and how much profit will be shared in the future or was shared in the past is shown under profit share 2023 section. Investor also sees cluster 2013 that investor has invested. Derivatives invested in each cluster invested 2014, performance of cluster 2015, and number of investors investing in a cluster 2016 are shown on user interface. Investor can buy 2017, sell 2018, exchange 2019 shares of each cluster. Cluster profit share schedule, and how much profit will be shared in the future or was shared in the past is shown under profit share 2024 section.

What claimed is:

1- A crowdfunding method, the method comprising:
crowdfunding cost of base station purchase, deployment, operation, optimization;
finding value of base station using base station valuation unit which is part of a base station or is a standalone unit residing inside or outside of wireless operator's network;
selling at least one share of a base station or groups of base stations to a single or to a group of investors using trading unit which is part of core network or is a standalone unit residing inside or outside of wireless operator's network;
creating smart contract between investors and wireless service provider, and recording smart contract in blockchain;
selling or reselling ownership in a base station, by investor, to any other third party which is interested in having ownership of a base station;
optimizing and managing the performance of base station if the profit of the base station is lower than a threshold for some duration of time;
sharing total profit of a base station with investors according to profit sharing schedule determined between wireless service provider and investor;
trading stocks and derivatives of a base station, a base station cluster, a group of base stations, a service market, a service region or the whole wireless network.

2- The method of trading, the method comprising:
buying, by investor, at least one share or derivative contract of a base station, or a base station cluster from wireless service provider at a specific purchase price by paying with any fiat currency, cryptocurrency, precious metals, commodities, stocks;
selling, by investor, at least one share or derivative contract of a base station, or a base station cluster at a price determined by base station valuation unit using any fiat currency, cryptocurrency, precious metals, commodities, stocks;
reselling, by investor, at least one share or derivative contract of a base station or a base station cluster to any other investor, at a price determined by investor, using any fiat currency, cryptocurrency, precious metals, commodities, stocks;
transferring, by investor, at least one share or derivative contract of a base station or base station cluster to any other investor for base station share, any other share, stock, any fiat currency, cryptocurrency, precious metals, commodities;
exchanging, by investor, at least one share or derivative contract of a base station or a base station cluster with any other investor for base station share, any other share, stock, any fiat currency, cryptocurrency, precious metals, commodities;
using user interface of trading unit to buy, to sell, to resell, to transfer shares or derivative contracts of a base station or a base station cluster;
recording any action of buying, selling, reselling, transferring of share or derivative contract of a base station and base station cluster in a blockchain.

3- The method of base station valuation, the method comprising:
determining selling price for a share/stock or for a derivative contract of base station and base station cluster based on at least one of location of base station, amount of frequency spectrum used by base station, age of base station, number of subscribers base station serves, amount of traffic that base station sends and receives, type of backhaul connection, capacity of backhaul connection, number of sectors, number of antennas, distance to data center, software version running, age of hardware running, number of alarms, key performance indicators, performance counters, type of wireless standard running, type of phones that base station is serving, services and application that base station is sending, receiving, coverage of base station, capacity of base station, average time duration that base station is live, number of current investors, type of current investor, the amount of money raised from investors, share/stock percentage owned by service provider, operational expenditures of base station, amount of financial liability/debt of base station;
creating financial stocks/shares for a base station, for a cluster of base stations;
creating financial derivative contracts for a base station or for a base station cluster by using any tangible asset or intangible asset of base station or base station cluster as an underlying asset value, and determining value of each derivative contract.
recording calculated value of a stock/a share of a base station, and base station cluster and value of a derivative contract of a base station, and base station cluster in a blockchain.

4- In claim 1 wherein said crowdfunding is the process of funding by a funder/investor, or a group of funders/investors who is/are interested in buying/owning share(s) of base station or base station cluster(s).

5- In claim 1 wherein said investor further means shareholder, stockholder, funder, owner of percentage of shares, owner of percentages of stocks.

6- In claim 1 wherein said trading unit is connected to accounting unit, and multiple base station value calculation units; and it provides user interface to service provider and investors to perform trading task, a set of trading tasks and to check status of their trades, their accounts, their account balances, their pending trades, profit sharing status, tax information, bank account information, wireless service provider information, base station information, base station cluster information, base station value, base station cluster value, number of shares a base station offers, number of shares a base station cluster offers, value of each share, number of derivative contracts a base station or base station cluster offer, and value of each derivative contract.

7- In claim 1 wherein said trading unit has base station and cluster ownership table comprising shareholder/investor identity, base station identity, cluster identity, and ownership percentages of shareholders/investors in base station(s).

8- In claim 1 wherein said trading unit holds full copy of blockchain, and shares copy of blockchain with other trading units, base station value calculation units, core network components, base stations, and with internal and external entities.

9- In claim 1 wherein said core network is 4G Core network or 5G Core network or 4G+5G Core network which comprising at least one of mobility management entity, home subscriber server, serving gateway, policy control rules function, authentication function, policy control function, access and mobility function, session management function, user plane function, user data management, application function, network exposure function, IP multimedia system, packet data network.

10- In claim 1 wherein said cost of base station further means at least one of capital expenditures, operational expenditures, and any other expenditures that has to be made in order to keep base station and base station cluster operational, and in order to keep delivering data and voice services to subscribers.

11- In claim 1 wherein said smart contract is a digital counterpart of real physical legal contract, and comprising at least one of identity of investor, identity of base station, identity of base station cluster, amount of money invested by investor, number of stocks/shares offered by base station, number of stocks/shares investor buys/sells/resells/exchanges/transfers, cost of base station/base station cluster, profit sharing schedule of base station or base station cluster, condition or a set of conditions to execute smart contract, and condition or a set of conditions to revoke smart contract.

12- In claim 1 wherein said smart contract is signed between each base station shareholder and wireless service provider; and it is signed between each shareholder of base station, and base station that shareholder holds share of.

13- The method of managing and optimizing performance as stated in claim 1 further comprising at least one of increasing coverage of base station, serving users who consume huge amount of data, reducing coverage of base station, increasing frequency spectrum used by base station, decreasing frequency spectrum used by base station, increasing number of services offered by base station, decreasing number of services offered by base station, increasing capacity of the base station, decreasing capacity of the base station, optimizing parameters of the base station, changing hardware of base station, improving hardware of base station, upgrading hardware of base station, upgrading software of base station, increasing backhaul capacity of base station, decreasing backhaul capacity of base station, changing parameter or parameters of base station, solving alarms issues of base station, solving base station and core network connection issues, solving base station and antenna connection issues, solving base station cabling issues, solving base station electricity or energy issues, solving base station cooling and heating issues, solving base station rent and real estate issues, solving base station smart contract issues, solving issues between base station and subscribers, solving issues between base station and wireless service provider, solving issues between wireless service provider and investors of base station.

14- In claim 1 wherein said wireless service provider means owner of wireless network infrastructure which includes base stations and base station clusters, cabling, core network components, real states, personnel, engineers, any hardware and software that is needed to deploy, to run, to manage, to optimize, to develop, and to operate wireless network.

15- In claim 1 wherein said investor further means subscribers, users of services provided, funders, individuals, investment firms, governments, government organizations, banks, universities, financial institutions, and any other person, group, company, organization, institution or groups of persons, companies, organizations, institutions which are interested in owning/buying/selling/reselling/exchanging/transferring share(s) of base station or base station cluster.

16- In claim 1 wherein said value further means tangible and intangible assets of base station or base station cluster.

17- In claim 1, wherein said base station valuation unit further comprising artificial intelligence hardware and software components to predict and to determine value of base station and base station cluster, and to dynamically calculate price of each issued stock, share and derivative contract of base station and base station cluster.

18- Buying, selling, reselling, exchanging, transferring shares/stocks/derivatives of base station in claim 2 occurs in an online, offline or any combination of online and offline places where value can be exchanged physically, electronically, or combination of both.

19- In claim 2 wherein said buying a share of base station further means buying a fractional share or stock, a part of whole share or stock, a whole share or stock, or more than one share or stock of base station or base station cluster.

20- In claim 3 wherein said base station valuation is performed in base station value calculation unit storing table showing base station identities/identifications, cluster identities/identifications, value index for each base station and base station cluster, shareholders/investors of each base station and base station cluster, valuation metrics used to value base station and base station cluster.

21- In claim 16, wherein said tangible assets further comprising at least one of hardware, software, cabling, and any hardware and software components that are needed to run base station, and to execute tasks of base station.

22- In claim 16, wherein said intangible assets further comprising at least one of any service, application, and traffic type base station delivers and receives, number of subscribers base station delivers its services to, quality of service base station delivers, quality of experience base station delivers, wireless standard that base station runs, software version of software running in base station, future upgrade plans of base station, future plans of wireless service provider, current profit amount of base station, amount of assets base station has, amount of liabilities base station has, amount of base station's equity, base station's cash flow, base station's income, base station's expense, earning per hertz, earning per subscriber, earning per hertz per subscriber, earning per square foot of coverage, earning per kilobyte/megabyte/gigabyte/terabyte/exabyte/′x′ byte of data delivered, where x represents any data unit, earning per minute of voice traffic, earning per default bearer, earning per dedicated bearer, earning per postpaid subscriber, earning per prepaid subscriber, number of services that base station delivers, diversity of services that base station delivers, total market value of wireless service providers.
